(19) United States
(12) Patent Application Publication
(10) Pub. No.: US 2023/0401542 A1
(43) Pub. Date: Dec. 14, 2023

(54) SYSTEMS AND METHODS FOR GENERATING APPLIANCE PERFORMANCE REPORTS

(71) Applicant: Haier US Appliance Solutions, Inc., Wilmington, DE (US)

(72) Inventors: Haitian Hu, Louisville, KY (US); Hairong Li, Louisville, KY (US); James Quentin Pollett, Louisville, KY (US)

(21) Appl. No.: 17/838,705

(22) Filed: Jun. 13, 2022

(51) Int. Cl. G06Q 10/00; G06Q 30/06; G06Q 10/06

(52) U.S. Cl. CPC G06Q 10/20; G06Q 30/0645; G06Q 10/06395

(57) ABSTRACT

An appliance performance report method for determining and communicating conditions of appliances. The method includes receiving appliance performance test parameters from a supervisory user of an appliance. The appliance performance test parameters include a test time frame for performing a self-diagnostic test. The method further includes directing the appliance to perform the self-diagnostic test during the test time frame, receiving diagnostic test data from the appliance following performance of the self-diagnostic test, generating a performance report using the diagnostic test data received from the appliance, and communicating the performance report to the supervisory user. An appliance performance report system including a controller is also described.

### FIELD OF THE INVENTION

The present subject matter relates generally to appliances, and more particularly to maintenance of appliances.

### BACKGROUND OF THE INVENTION

Appliances are used in various settings including long or short term rental properties, hotels, dormitories, and other dwellings where more than one occupant or tenant may reside during the lifetime of the appliances. For example, a refrigerator may be located in a dwelling over many owners or renters. Same for microwaves, room air conditioners, washing machines, dryers, or other household appliances. A landowner or property manager may be responsible for the upkeep or maintenance of such appliances, while a renter is the user of the appliances.

For property managers or appliance owners, management and maintenance of these appliances may be difficult. Similarly, for users of such appliances, proper use of an unfamiliar appliance may be difficult. In the case of short term dwellings, such as short term rental units, appliances may require maintenance without the knowledge of the property managers thereof, and users may expect the appliances to be in good working order during their stay, with repairs or service calls during short term stays being viewed as an improper management of the rental unit. Service calls during short term stays or nonfunctioning appliances during short term stays may result in unsatisfied renters. Further, a renter may not know how to adjust the settings of an appliance in a rented dwelling, which may result in unnecessary service visits, or unsatisfied renters who erroneously think an appliance in a rented dwelling was not working during their stay. For example, an ice maker may be turned off in a refrigerator, and a renter who is unfamiliar with the appliance may believe the ice maker is broken, when in fact it just needs to be turned on. An unsatisfactory stay or an unnecessary service call may result from such situations.

Accordingly, a system improving communication to property managers or renters regarding the condition of appliances in rental units would be beneficial. Additionally, a method of informing renters and property managers of the functionality of appliances in a dwelling prior to the renters' stay in the dwelling would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a non-transitory computer medium is provided. The non-transitory computer medium may include computer-executable instructions that, when executed by one or more processors of an appliance performance report system, may cause the one or more processors to receive appliance performance test parameters from a supervisory user of an appliance. The appliance performance test parameters may include a test time frame for performing a self-diagnostic test on the appliance. The computer-executable instructions may further cause the one or more processors to direct the appliance to perform the self-diagnostic test during the test frame, receive diagnostic test data from the appliance following performance of the self-diagnostic test, generate a performance report using the diagnostic test data received from the appliance, and communicate the performance report to the supervisory user.

In another exemplary aspect of the present disclosure, an appliance performance report method for determining and communicating conditions of appliances is provided. The method for determining and communicating conditions of appliances may include the steps of receiving appliance performance test parameters from a supervisory user of an appliance, directing the appliance to perform the self-diagnostic test, receiving diagnostic test data from the appliance following performance of the self-diagnostic test, generating a performance report, and communicating the performance report to the supervisory user. The appliance performance test parameters may include a test time frame for performing the self-diagnostic test. The step of directing the appliance to perform the self-diagnostic test may be directed during the test time frame. The step of generating the performance report may be done using the diagnostic test data received from the appliance.

In another exemplary aspect of the present disclosure, an appliance performance report system is provided. The appliance performance report system may be for communicating conditions of appliances capable of performing a self-diagnostic test and having a network interface. The appliance performance report system may include a controller in operative communication with an appliance through the network interface. The controller may be configured to receive appliance performance test parameters from a supervisory user of the appliance. The performance test parameters may include a test time frame for performing the self-diagnostic test. The controller may further be configured to direct the appliance to perform the self-diagnostic test during the test time frame, receive diagnostic test data from the appliance following performance of the self-diagnostic test, generate a performance report using the diagnostic test data received from the appliance, and communicate the performance report to the supervisory user.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of an appliance performance report system according to exemplary embodiments of the present disclosure.

FIG. 2 provides a provides an alternative schematic view of an exemplary appliance performance report system according to exemplary embodiments of the present disclosure.

FIG. 3 provides an exemplary appliance issue report request table according to exemplary embodiments of the present disclosure.

FIG. 4 provides an exemplary supervisory performance report according to exemplary embodiments of the present disclosure.

FIG. 5 provides an exemplary rental performance report according to exemplary embodiments of the present disclosure.

FIG. 6 provides a flow chart illustrating an appliance performance report method according to exemplary embodiments of the present disclosure.

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). Terms such as “inner” and “outer” refer to relative directions with respect to the interior and exterior of the household appliance, and in particular the chamber(s) defined therein. For example, “inner” or “inward” refers to the direction towards the interior of the household appliance. Terms such as “left,” “right,” “front,” “back,” “top,” or “bottom” are used with reference to the perspective of a user accessing the appliance (e.g., when the door is in the closed position). For example, a user stands in front of the appliance to open a door and reaches into the internal chamber(s) to access items therein.

Aspects of the present subject matter advantageously provide appliance performance report systems that may provide a system for a supervisory user (e.g., an owner or a property manager) of a dwelling having at least one household appliance to remotely obtain or access appliance performance data in a report between rental periods of the dwelling. In some embodiments, the systems described herein may provide a way to perform a self-diagnostic test specific to each appliance in the system at a designated time and receive a report that includes the results of the self-diagnostic test, including recent historical data analysis or current appliance settings. Further, embodiments described herein may allow a rental user to access a performance report of the appliances of the system. Such access may be limited by the supervisory user to a time period during the rental user's stay in the dwelling.

Embodiments herein may also include methods to perform testing of appliances (e.g., located in a dwelling) at a designated time, generate performance reports based on that testing, and communicate or give access to performance reports to supervisory users or rental users. Advantageously, supervisory users may be able to assess the condition of connected appliances remotely, and in between renters, and rental users may be able to quickly determine the condition or settings of appliances in the dwelling. This may be particularly advantageous when rental users are unfamiliar with appliances within a dwelling they are renting and may reduce unnecessary service calls during rental stays. In some embodiments, generation of performance reports in between rental periods in a dwelling may allow for appliance repairs in between rental agreements, thus reducing unsatisfactory stays for renters of dwellings. This may benefit both short-term rentals and long-term rentals.

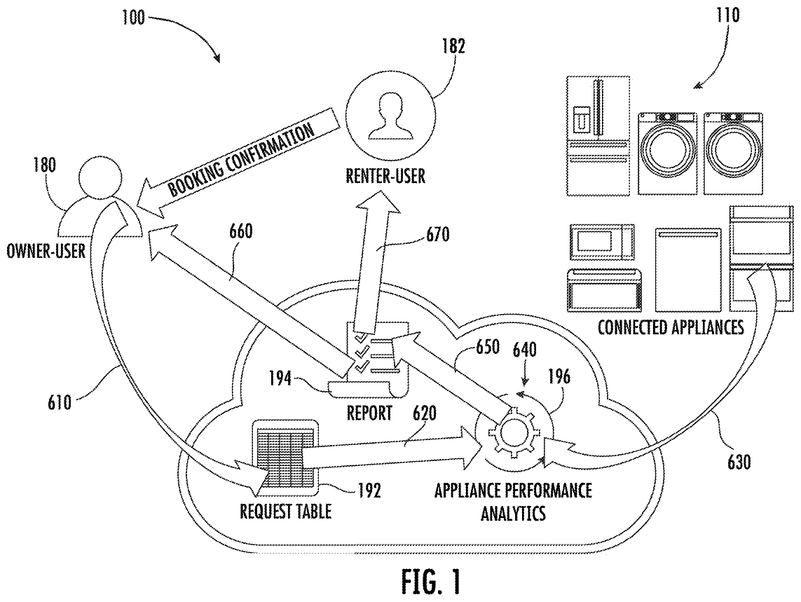

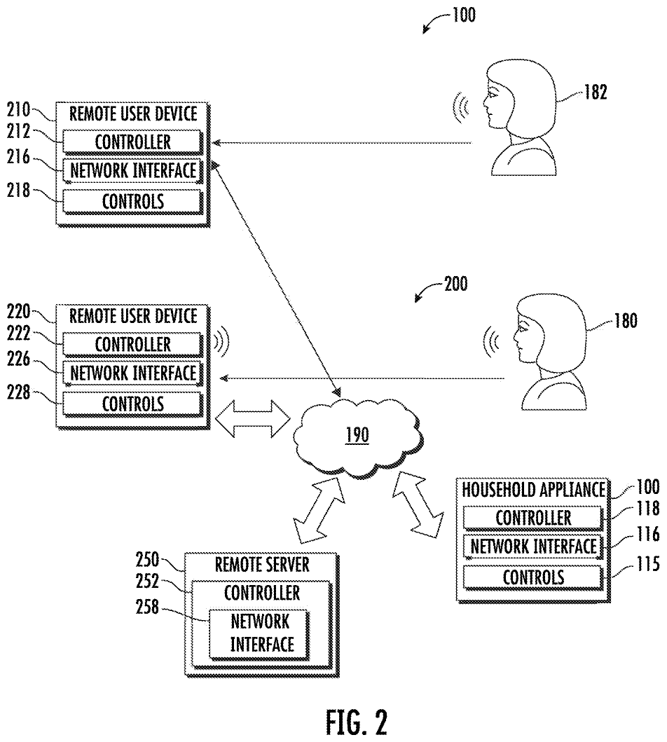

Turning now to the figures, FIGS. 1 and 2 illustrate embodiments of an appliance performance report system 100 including a plurality of household appliances 110 according to exemplary embodiments of the present disclosure. Appliance performance report system 100 may communicate conditions of at least one appliance 110. Though a plurality of appliances 110 are shown in FIG. 1, the system may include one or more household appliances 110 in some embodiments.

Generally, each appliance 110 may respectively include a cabinet 112, at least one sensor 114, or a network interface 116. Each appliance 110 may be capable of performing a self-diagnostic test. The self-diagnostic test may be specific to each corresponding appliance. As will be described in more detail below, each appliance 110 may have a controller 118 to implement self-diagnostic tests. In general, these tests are intended to determine whether appliance 110 is operating properly with no faulty components or sub-components or that appliance 110 requires maintenance.

Although exemplary self-diagnostic tests are described below, it should be appreciated that, as would be understood by a person of ordinary skill in the art, that other self-diagnostic tests may be run in addition to or instead of the tests described herein, as would be understood.

As generally shown throughout FIGS. 1 through 3, each appliance 110 includes a cabinet (not shown), and an internal chamber (not shown). In some embodiments, one or more communications features (e.g., controls, network interface 116) may be mounted on each respective cabinet.

In general, system of connected appliances 110 may include any suitable number, type, and configuration of appliances, remote servers, network devices, and/or other external devices that are able to communicate with each other or are otherwise interconnected. This interconnection, interlinking, and interoperability of multiple appliances and/or devices may commonly be referred to as “smart home” or “connected home” appliance interconnectivity.

This communication may be achieved using any suitable communication protocols and interfaces, such as one or more wireless networks, to transfer useful information or data. For example, interconnected appliances may share consumer usage data, user preferences, appliance operating parameters, operating conditions, and/or other useful data or information. Sharing data between and among various appliances or other devices within the system of connected appliances 110 may result in improved overall system operation, including improved efficiency of management of rental units. In addition, user interaction, monitoring, control, and overall satisfaction with the system of connected appliances 110 may be enhanced.

Each of the appliances 110 will be described below according to exemplary embodiments of the present subject matter. However, it should be appreciated that the specific appliance types and configurations are only exemplary and are provided to facilitate discussion regarding the use and operation of an exemplary system 100 of connected devices. The scope of the present subject matter is not limited to the number, type, and configurations of appliances set forth herein.

Household appliance 110 may be provided as a refrigerator appliance that defines one or more chilled chambers for receipt of food items for storage. Household appliance 110 may be provided as a microwave appliance that defines one or more chambers for receipt of food items for heating or cooking. Household appliance 110 may be provided as a room air conditioning appliance that defines one or more chambers for conditioning air to be motivated into a room. Household appliance 110 may be provided as a dishwasher appliance that defines one or more chambers for receipt of articles (e.g., dishes) for washing. Household appliance 110 may be provided as an oven appliance that defines one or more cooking chambers for receipt of food items for cooking. Household appliance 110 may be provided as a dryer appliance that defines one or more drying chambers for receipt of articles (e.g., damp clothes) for drying. Household appliance 110 may be provided as a washing machine appliance that defines one or more washing chambers (not shown) for receipt of articles (e.g., clothes) for washing.

For example, the system of connected appliances 110 may include any suitable number and type of “appliances,” such as “household appliances.” These terms are used herein to describe appliances typically used or intended for common domestic tasks, e.g., such as laundry appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions in addition to network communication and data processing. Moreover, although several appliances are illustrated, various embodiments of the present subject matter may include any suitable number, type, and configuration of appliances, each of which may transmit, receive, and/or relay signals among connected appliances and/or other external devices.

Further, as shown in FIG. 2, household appliance 110 may include a controller 118 and controls 115 (e.g., a user interface panel). Controls 115 may, for example, provide selections for user manipulation of the operation of an appliance. Appliance 110 may further include a set of user-selectable settings configured to adjust various functions of appliance 110. Controls 115 may be used, for example, to specify selections for the set of user-selectable settings for appliance 110. Settings may include turning on or off features of appliance 110 (e.g., turning on an ice maker, turning on a timer, turning on a power setting, etc.), adjusting a measurable setting (e.g., temperature, water flow, cycle setting, or power setting, etc.), or other known functions.

In various embodiments, the user interface panel, or controls 115 may represent a general purpose I/O (“GPIO”) device or functional block. In some embodiments, the controls 115 may include or be in provided as a user input device e.g., controls 115 in FIGS. 1 and 2, such as one or more of a variety of digital, analog, electrical, mechanical, or electro-mechanical input devices including rotary dials, control knobs, push buttons, and touch pads. Controls 115 may include a display component, such as a digital or analog display device designed to provide operational feedback to a user. The display component may also be a touchscreen capable of receiving a user input, such that the display component may also be a user input device in addition to or instead of the user input device or controls 115.

Generally, controller 118 may be in operative communication with controls 115. The controls 115 may be in communication with the controller 118 via, for example, one or more signal lines or shared communication busses. Input/output (“I/O”) signals may be routed between controller 118 and various operational components of the appliances 110. Operation of the appliances 110 may each be regulated by the respective controller 118 that is operatively coupled to the corresponding controls 115. For instance, in response to user manipulation of controls 115, controller 118 may operate various components of the appliance 110. Each controller 118 may include a memory and one or more microprocessors, CPUs, or the like, such as general or special purpose microprocessors operable to execute programming instructions or micro-control code associated with operation of appliance 110 (e.g., “instructions” and “data” with memory, and a processor in controller 118). The memory may represent random access memory such as DRAM or read only memory such as ROM or FLASH. In one embodiment, the processor executes programming instructions stored in memory. The memory may be a separate component from the processor or may be included onboard within the processor. Alternatively, a controller 118 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

The controller 118 may be programmed to operate the respective appliance 110 by executing instructions stored in memory. For example, the instructions may be software or any set of instructions that when executed by the processing device, cause the processing device to perform operations. Controller 118 can include one or more processor(s) and associated memory device(s) configured to perform a variety of computer-implemented functions or instructions (e.g. performing the methods, steps, calculations and the like and storing relevant data as disclosed herein). It should be noted that controllers as disclosed herein (e.g., controllers of appliances 110) are capable of and may be operable to perform any methods and associated method steps as disclosed herein.

In some embodiments, appliance 110 (e.g., by use of controller 118) may further be configured to communicate with one or more separate, external devices, such as a remote user device, a remote server, or another household appliance. Such communication may be performed either directly or via one or more intermediate networks (e.g., a wide area network 190, such as the internet), as will be discussed in more detail below.

As shown in FIG. 2, appliance 110 includes network interface 116. In some embodiments, controller 118 includes a network interface 116 such that appliance 110 can connect to and communicate over one or more networks (e.g., network 190) with one or more network nodes. Network connection device 116 can be an onboard component of controller 118 or it can be a separate, off board component. Controller 118 can also include one or more transmitting, receiving, or transceiving components for transmitting/receiving communications with other devices communicatively coupled across network 190. Additionally or alternatively, one or more transmitting, receiving, or transceiving components can be located off board controller 118.

As shown in FIG. 2, appliance performance report system 100 may include a supervisory remote user device 220. Supervisory remote user device 220 may include a controller 222, a network interface 226, and controls 228. In some embodiments, appliance performance report system 100 may include a rental remote user device 210. Rental remote user device 210 may include a controller 212, a network interface 216, and controls 218. In some embodiments, system 100 may further include a remote server 250 which may have a controller 252 and a network interface 258.

Controller of remote user device 220 may generally perform similar functions to that of controller 118 of appliances 110. Additionally or alternatively, controls 228 may, for example, provide selections for user manipulation of the operation of an appliance 110 or a user device 220.

Further, the controllers of system 100 may be programmed to operate the device within which they are stored (e.g., controller 212 may operate user device 210, controller 222 may operate user device 220, controller 118 may operate appliance 110, etc.) by executing instructions stored in memory. For example, a controller of system 100 may be a non-transitory computer readable medium comprising computer-executable instructions, which, when executed by one or more processors of a computing system may cause one or more processors of the controllers to perform methods described herein (e.g., appliance performance report method 600, which will be described in more detail below). For example, the instructions may be software or any set of instructions that when executed by the processing device, cause the processing device to perform operations. Controllers can include one or more processor(s) and associated memory device(s) configured to perform a variety of computer-implemented functions or instructions (e.g. performing the methods, steps, calculations and the like and storing relevant data as disclosed herein). It should be noted that controllers as disclosed herein are capable of and may be operable to perform any methods and associated method steps (e.g., as, or as part of, a commissioning operation) as disclosed herein.

In some embodiments, one or more controllers of system 100 may further be configured to communicate with one or more separate, external devices, such as a remote user device 210 or 220, a remote server 250, or another household appliance. Such communication may be performed either directly or via one or more intermediate networks (e.g., a wide area network 190, such as the internet), as will be discussed in more detail below.

As shown in FIG. 2, controllers of system 100 may include or be in communication with network interfaces (e.g., controller 118 may be in communication with network interface 116, controller 212 may be in communication with network interface 216, controller 222 may be in communication with network interface 226, controller 252 may be in communication with network interface 258) such that devices of system 100 can connect to and communicate over one or more networks (e.g., network 190) with one or more network nodes. Network connection devices can be an onboard component of controllers, or it can be a separate, off board component. The controller can also include one or more transmitting, receiving, or transceiving components for transmitting/receiving communications with other devices communicatively coupled across network 190. Additionally or alternatively, one or more transmitting, receiving, or transceiving components can be located off board controller.

The remaining description will be described with reference to controller 222. As will be understood by those skilled in the art, controller 222 is provided by example only, and the present subject matter may be used with other controllers of system 100 including but not limited to, controller 118, controller 212, or controller 252, or another controller of an appliance of system 100. Thus embodiments described herein may be used or performed with other controllers or combinations of controllers, etc.

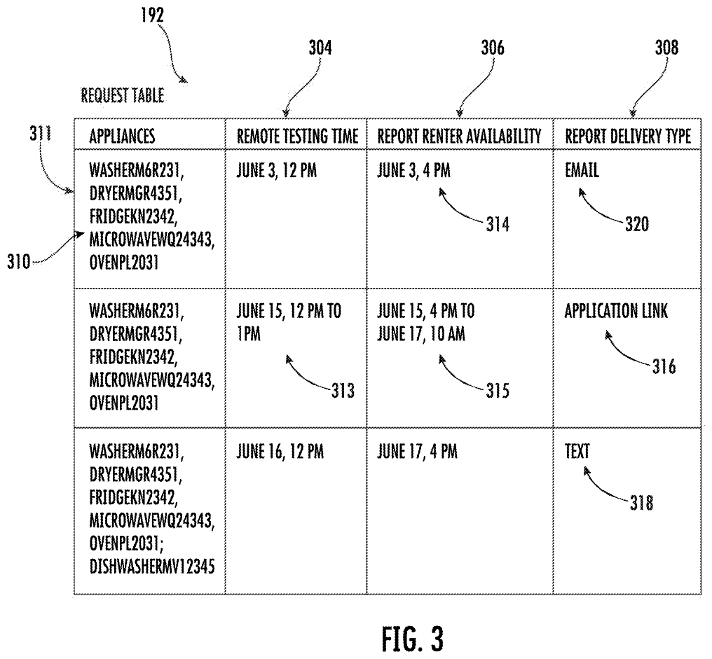

Generally, controller 222 may be configured to perform an appliance performance report operation. In performing the operation, controller 222 may be configured to receive appliance test parameters from a supervisory user 180 of appliance 110. As described herein, a supervisory user 180 may be an owner of the appliance or the dwelling where the appliance of system 100 is located, or a manager of the dwelling where the appliance of system 100 is located. For example, a supervisory user 180 may be a property owner, or a property manager. Generally, the supervisory user 180 may be a user responsible for the maintenance of the appliance of system 100. In some embodiments, appliance performance test parameters are recorded in a request table 192, as shown in FIGS. 1 and 3. Supervisory user 180 may input performance test parameters into request table 192 (e.g., by using controls 228 on remote user device 220). Request table 192 may be stored by controller 222 or stored remotely by way of network 190, for example, on remote server 250, as shown in FIG. 1.

In some embodiments, supervisory user 180 may use controls 115 to input appliance performance test parameters. In some embodiments, request table 192 may be stored by controller 118.

As shown in request table 192 of FIG. 3, appliance performance test parameters include appliance profile data (e.g., appliance unique identifier list 311 related to appliances of system 100 in column 302). Appliance profile data may include a serial number, model number or other unique identifier of each appliance in the plurality of appliances of system 100. Alternatively, supervisory user 180 may select which appliances of system 100 are to be included in performance report by listing a subset of available appliances of system 100 (e.g., by selecting the unique identifier for each appliance desired and inputting the unique identifier or identifiers into request table 192). For example, microwave appliance 110 may be identified by a unique identifier 310. Unique identifier 310 is included in unique identifier list 311 of appliance column 302, indicating performance report 194 will include data on microwave appliance 110. Supervisory user 180 may input appliance identifiers (e.g., identifier 310) into appliance performance analytics program 196 prior to the generation of request table 192 or synonymously with the generation of request table 192. The appliances listed in appliance unique identifier list 311 may correspond to appliances (e.g., appliances 110 in system 100) in a dwelling rented by a rental user 182 that are to have a performance test performed remotely by the system 100 prior to occupancy of the dwelling by rental user 182. As used herein, a rental user 182 is a user who has rented the dwelling where the appliance of system 100 is located. The rental user 182 may be a short term renter, or a long term renter. Generally, the rental user 182 has rented the dwelling where the appliance of system 100 is located from the supervisory user 180 (either directly or indirectly). In some examples, the rental user 182 is the user of the appliance of system 100 but is not responsible for the maintenance of the appliance of system 100.

As shown in FIG. 3, appliance performance test parameters may include a test time frame (e.g., remote testing time 312 in remote testing time column 304) for performing a self-diagnostic test. Test time frame may include a time, as shown in remote testing time 312, or may include a time range, such as remote testing time 313. For example, the remote testing time 312 may include a test start time, a test end time, and/or a test duration.

As shown, appliance performance test parameters may further include a renting-report time frame (e.g., renting-report time frame 314 in report renter availability column 306 for a rental user to have access to a performance report 194). In some embodiments, renting-report time frame may correspond to a time period where rental user 182 is occupying a dwelling housing appliance 110. For example, supervisory user 180 may receive a rental request from rental user 182. Supervisory user 180 may accept the rental request, and record renting-report time frame 314 to be roughly equal to the length, date, or time of the rental request. As shown, in some embodiments, renting-report time frame 314 may be a time to begin access, or a time to send performance report 194 to rental user 182. In some embodiments, a renting-report time frame 315 may be a time period to allow access to performance report 194, the time frame 315 having a beginning time and an ending time, or a beginning time and a time length in the recorded performance test parameters in request table 192.

Additionally or alternatively, appliance performance test parameters may further comprise a performance report delivery type (e.g., report delivery type 316, 318, 320 in performance report delivery type column 308). Performance report delivery type may include email 320, an application link 318, short message service message 316, or an equivalent delivery type. In some examples, supervisory user 180 may request a preferred report delivery type as part of a rental request from rental user 182. In some embodiments, supervisory user 180 may independently determine the preferred report delivery type.

There are multiple rows shown in request table 192. Supervisory user 180 may enter multiple requests for performance reports to be generated, one report request per row. Each row in request table 192 may be for a different time period, for a different rental request, or for a different rental user. In some embodiments, each row in request table 192 may represent a different request for a performance report 194.

Controller 222 may further be configured to direct the appliance to perform a self-diagnostic test during the test time frame. Controller 222 may be configured to direct appliance 110 to perform the self-diagnostic test following receipt of appliance test parameters from supervisory user 180. In embodiments with multiple appliances of system 100 selected in request table 192, controller 222 may be configured to direct each appliance identified in unique identifier list 311 to each perform a self-diagnostic test during the test time frame (e.g., test time frame 312). For example, in unique identifier list 311, washer, dryer, refrigerator, microwave, and oven are listed. In this example, controller 222 is configured to direct each appliance 110 to each perform a self-diagnostic test during the test time frame (e.g., test time frame 312 of June 3, at 12 pm). As previously described, each appliance in system 100 may be configured to perform a self-diagnostic test specific to each appliance. For example, appliance 110 may be configured to perform a self-diagnostic test that checks that refrigeration activities are operating as normal while appliance 110 may be configured to perform a self-diagnostic test that check that microwave activities are operating within normal parameters.

In some examples, self-diagnostic tests may be a test of electrical currents or voltages at different places or during different activities of the appliance, as would be understood. Self-diagnostic test may produce diagnostic test data based on at least one parameter or measurement. For example, a self-diagnostic test for a refrigerator may include receiving a temperature reading for each refrigeration chamber, checking electronic signals in cooling systems to ensure they are functioning properly, or sending signals to an ice-maker. A self-diagnostic test for a microwave may include directing a magnetron to turn on and collecting data from an inner chamber when the magnetron is turned on. A self-diagnostic test for an oven may include directing an oven heating element to turn on and detecting an internal oven chamber temperature. A self-diagnostic test for a washing machine may include directing a motor to rotate a wash basket, a pump to drain fluid from a tub, and detecting whether rotation or draining occurred by sensor or electronic current. A self-diagnostic test for a dryer may include directing a heater to turn on and detecting a temperature inside an inner chamber. A self-diagnostic test for an air conditioning unit may include directing air flow to be turned on and detecting whether air flows across a sensor or directing a heater to turn on and detecting an internal chamber temperature reading. Other self-diagnostic tests may also be performed, as would be understood.

Generally, all appliances (e.g., appliances 110 specified in list 311) directed to perform a self-diagnostic test may perform the self-diagnostic test simultaneously at the remote testing time specified (e.g., remote testing time 312). In some embodiments, self-diagnostic tests may be completed in under about thirty minutes. In some embodiments, self-diagnostic tests may be completed in under about twenty minutes. In some embodiments, self-diagnostic tests may be completed in between about ten and about fifteen minutes. In some embodiments, self-diagnostic tests may be completed in less than about ten minutes.

The self-diagnostic test may include measurement of at least one appliance parameter. Appliance parameters may include at least one measurement of temperature, current, voltage, pressure, water-level, rotational speed, or etc., which may be recorded as diagnostic test data.

Additionally or alternatively, the self-diagnostic test may further include a historical data analysis of at least one appliance parameter. The at least one appliance parameter may be previously recorded over a predetermined time period. For example, at least one appliance parameter may be recorded daily, hourly, or for some other time frame, and recorded by controller 118 of appliance 110. Each recording of the at least one appliance parameter may be added to historical data for appliance 110.

Each appliance in system 100 may similarly record data for historical data analysis. Historical data analysis may be performed by appliance 110, by remote server 250 or by remote user device 220. Historical data analysis may be a part of test data acquired during the self-diagnostic test.

Historical data may be analyzed over a most recent time period. For example, historical data may be collected by a controller (e.g., controller 118, 228, or 252) that spans seven days prior to direction of the self-diagnostic test. Other time spans than the last seven days may also be used. In some embodiments, a time span of about thirty days or less may be used. In some embodiments, a time span of between five and ten days may be used. In some embodiments, a time span of between one and five days may be used. In some embodiments, the length of time to analyze historical data may be selected by supervisory user 180 and may be included in appliance performance test parameters or in request table 192. It is noted that such is not shown in request table 192 in FIG. 3.

In some embodiments, historical data analysis may include a determination of any error notifications or error codes noted during the time period specified for historical data analysis. In other words, historical data analysis may include data on any error codes or out of range measurements taken in a time period recent to or proximate to the remote testing time specified in request table 192.

Controller 222 may further be configured to receive diagnostic test data from appliance 110 following performance of the self-diagnostic test. In examples where more than one appliance (e.g., appliances 110 specified in list 311) has been directed to perform a self-diagnostic test, controller 222 may be configured to receive diagnostic test data from each appliance in system 100 that was directed to perform a self-diagnostic test. Diagnostic test data may include data from self-diagnostic tests, including measurements taken during self-diagnostic test performed at remote testing time 312. Additionally or alternatively, diagnostic test data may include historical data analysis or error notifications from historical data analysis. In some embodiments, diagnostic test data may be organized by appliance. In some examples, diagnostic test data from each appliance in system 100 is organized by each respective appliance 110 in system 100.

Controller 222 may further be configured to analyze diagnostic test data following receipt of diagnostic test data from appliance 110. In examples where more than one appliance performed a self-diagnostic test, controller 222 is configured to analyze diagnostic test data for each appliance of system 100 that performed a self-diagnostic test. Analysis of diagnostic test data may include determining a current state for appliance 110 (or for each appliance tested in system 100). Analysis of diagnostic test data may include analysis of historical data, including a repair analysis of any error notifications received with the historical data analysis received.

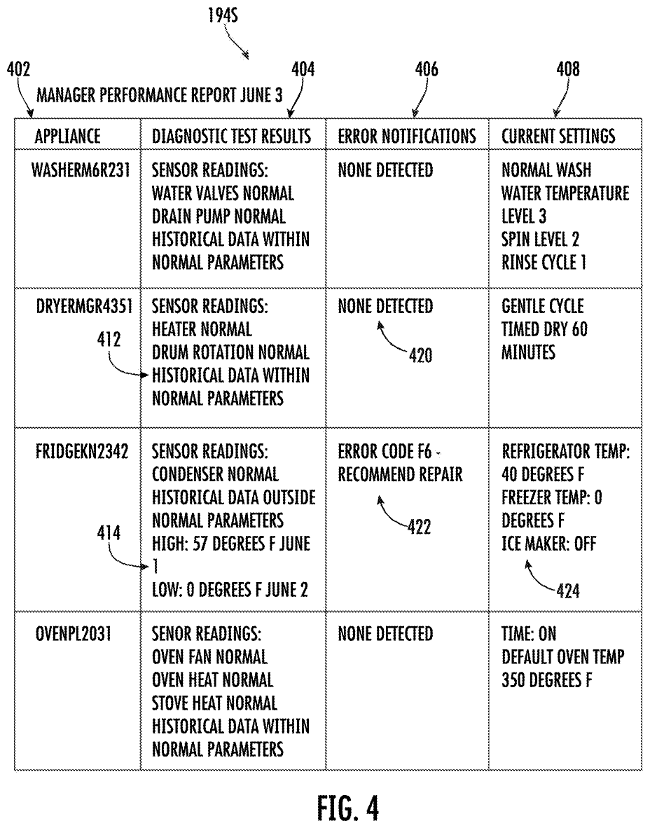

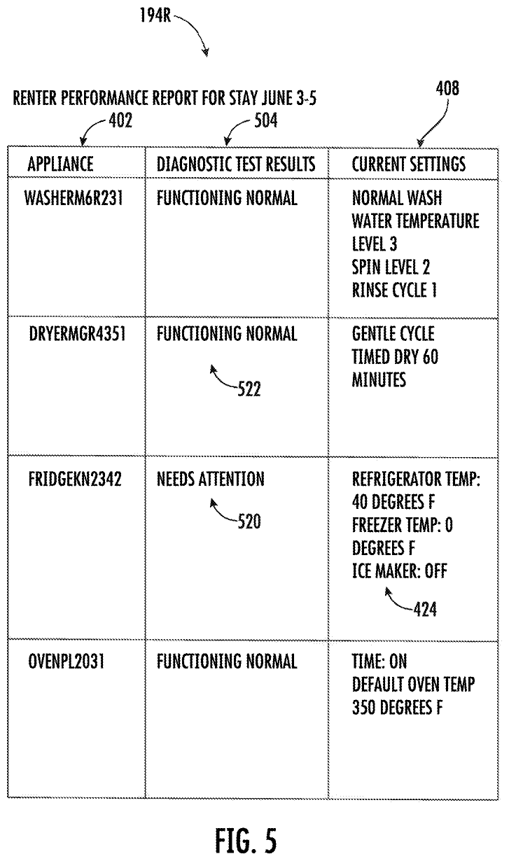

As shown in FIGS. 4 and 5, controller 222 may be configured to generate a performance report 194S or 194R. In some embodiments, controller 222 may generate one performance report, such as performance report 194S in FIG. 4. In some embodiments, performance report 194S may be a supervisory performance report 194S, and controller 222 may further generate a rental performance report 194R, as shown in FIG. 5. Supervisory performance report 194S may have a detailed report of diagnostic test data. Rental performance report 194R may have a summary of diagnostic test data. It is noted that performance report 194 as shown in FIG. 1 may include one or more performance reports 194S or 194R.

For example, performance reports 194S and 194R may include an appliance list 402 of appliances in system 100 that were directed to perform a self-diagnostic test. Performance reports 194S and 194R may include diagnostic test results 404 or 504 for each appliance in appliance list 402. Performance reports 194S and 194R may further include a settings list 408 of a current state of the set of user-selectable settings for the appliances in appliance list 402 (e.g., appliance 110).

Settings list 408 may include a current state of major settings of each appliance in appliance list 402. For example, in setting cell 424, refrigerator appliance 110 settings are summarized, including current temperature settings for a refrigerator chamber and a freezer chamber and a current status of an ice maker (not shown). Advantageously, settings summary may inform both supervisory user 180 and rental user 182 of the current settings of the appliances rented in a dwelling by rental user 182. If rental user 182 is not familiar with an appliance 110 in a rented dwelling, performance report may inform rental user 182 as to whether the appliance is functioning within normal parameters or needs repair. For example, setting cell 424 indicates that ice maker of refrigerator appliance 110 is turned off. By using performance report to inform rental user 182 of the off setting of the ice maker of refrigerator appliance 110, rental user 182 is less likely to believe refrigerator appliance 110 does not produce ice, or that ice maker of refrigerator appliance 110 is broken and needs repair. Supervisory user 180 is also informed of the current settings and may make adjustments prior to use of refrigerator appliance 110 by rental user 182, if desired. In this manner, unnecessary repair or service calls may be decreased or lessened, and renter user satisfaction may be increased.

In performance report 194S, diagnostic test results 404 may be a detailed report of diagnostic test data. For example, diagnostic test results 404 includes a summary of sensor readings 412 of appliances in appliance list 402, and a summary of historical data analysis 414. Further, performance report 194S may include an error event notification, as shown in FIG. 4 as a list of error notifications 406 for each appliance in appliance list 402. For example, if an appliance has no error notifications, a note may be made for that appliance, as shown in cell 420. Further, if an appliance (e.g., appliance 110) has an error notification, an error notification detailing the error identified may be placed in the error cell 422 of list of error notifications 406. In some embodiments, error cell 422 may further indicate a recommended course of action for supervisory user 180, as shown in FIG. 5.

In performance report 194R, diagnostic test results 504 may be a summary report or current status determination (e.g., a normal status 522 or an error status 520) for each appliance in the plurality of appliances in appliance list 402. Normal status 522 may be used with appliances in appliance list 402 determined to be functioning within normal parameters based on diagnostic test data. Error status 520 may be used with appliances in appliance list 402 determined to be functioning outside of normal parameters, including having an error notification, to appliances determined to not be functioning (e.g., if no diagnostic test data is received from an appliance).

Following generation of performance report 194, controller 222 may be configured to communicate performance report (e.g., 194R or 194S) to supervisory user 180. In some embodiments, controller 222 may communicate performance report 194 to display on remote user device 220. In some embodiments, communicating performance report to supervisory user 180 may include sending a notification or message to supervisory user 180, for example, directing a notification or message to remote user device 220.

Controller 222 may also be configured to provide access to performance report 194 (e.g., performance report 194R or 194S, hereinafter referred to by “performance report 194” unless otherwise specified) to rental user 182. For example, controller 222 may be configured to provide access to performance report 194 by sending a notification, allowing access on an application, or an equivalent method on rental user device 210.

In some embodiments, controller 222 is configured to provide access to performance report 194 in the performance report delivery type specified in the appliance performance test parameters. For example, for performance report 194 available “June 3, at 4 pm” in report time frame 314, performance report 194 may be delivered by email, as specified in report delivery type 320 of FIG. 3.

In some embodiments, controller 222 is configured to communicate supervisory performance report 194S to supervisory user 180 and provide access to only rental performance report 194R to rental user 182. For example, supervisory performance report 194S may be communicated to remote user device 220 and access to the rental performance report 194R may be provided via rental user device 210. In some embodiments, supervisory user 180 may have access to both supervisory performance report 194S and rental performance report 194R.

Generally, controller may further be configured to communicate performance report 194 to supervisory user 180 prior to admittance of rental user 182 to a dwelling that houses appliance 110 (e.g., prior to the anticipated arrival or check-in time of rental user 182). In some embodiments, communication of performance report 194 to supervisory user 180 in this manner may allow supervisory user 180 to make any needed repairs or perform maintenance on any appliances in performance report 194, prior to admittance of rental user 182 to the dwelling that houses appliance 110. Advantageously, supervisory user 180 may use system 100 to remotely manage appliances in rental dwellings, and such may be particularly useful in situations with a short turnaround time between rental periods.

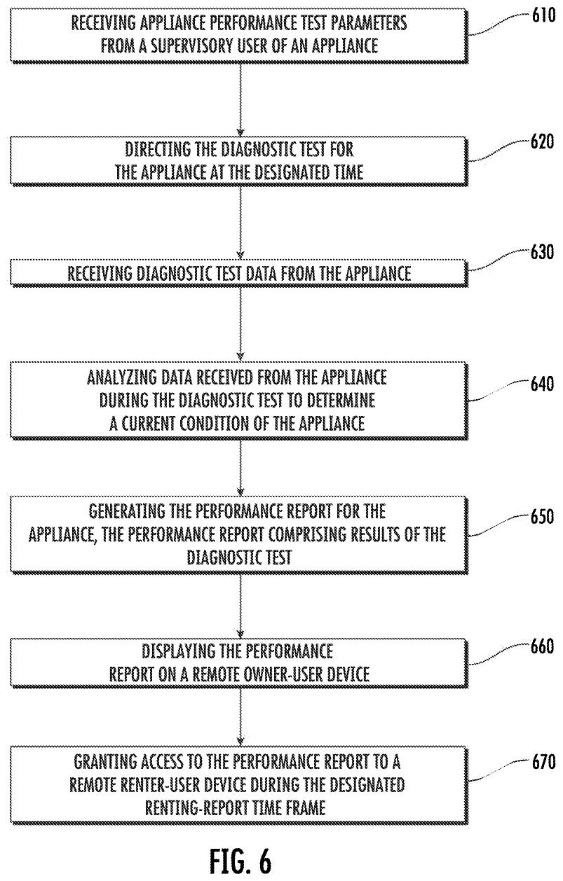

Referring now to FIG. 6, various methods (e.g., appliance performance report method 600) may be provided for use with system 100 in accordance with the present disclosure. In some embodiments, all, or some of the various steps of the method(s) may be performed by a suitable controller (e.g., controller 118, controller 212, controller 222, or controller 252). Thus, controller 118, 212, 222, or 252 may be configured to direct such a method. As previously described, controller 222 will be used in further description, with the understanding that any controller 118, controller 212, controller 222, or controller 252 could perform some or any of the method steps described herein. During such methods, controller 222 may receive inputs and transmit outputs from various other portions of the system 100. For example, the controller 222 may send signals to and receive signals from another controller, or a part of any appliance 110. The present methods may advantageously aid in determining and communicating conditions of appliances. Further, disclosed methods may direct the performance of self-diagnostic tests and the generation of performance reports for remote management of appliances in rental dwellings to inform supervisory users and rental users.

FIG. 6 depicts steps performed in a particular order for purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

At step 610, method 600 includes receiving appliance performance test parameters from a supervisory user of an appliance. Appliance performance test parameters may include a test time frame for performing a self-diagnostic test. Appliance performance test parameters may further include other elements as included in the above description of system 100, including, but not limited to a renting-report time frame for a rental user to have access to the performance report.

At step 620, method 600 includes directing the appliance to perform the self-diagnostic test during the test time frame. Step 620 may be performed in response to receipt of appliance test parameters.

At step 630, method 600 includes receiving diagnostic test data from the appliance. Receipt of diagnostic test data may follow performance of the self-diagnostic test by the appliance. Diagnostic test data may include a historical data analysis of at least one appliance parameter, the at least one appliance parameter previously recorded over a predetermined time period. The historical data analysis may come from historical data as described as a part of system 100 above. In some embodiments, diagnostic test data may include a set of user-selectable settings configured to adjust various functions of the appliance. The set of user-selectable settings may include various parameters and functions of the appliance, including as described in the description of system 100 above.

In some embodiments, at step 640, method 600 includes analyzing diagnostic test data. Analysis of diagnostic test data may follow receipt of diagnostic test data from the appliance. Analysis of diagnostic test data may include inputting diagnostic test data into an appliance performance analytics program 196. For example, remote server may include empirical data related to the appliance for conditions that the appliance should meet. Performance analytics program 196 may compare empirical data to measured data (e.g., collected during self-diagnostic tests or historical data previously recorded over the predetermined time period) and determine whether measured data indicates the appliance is functioning within specifications or likely needs maintenance or repairs. Appliance performance analytics program 196 may compare received data against a set of standardized data accessible via remote network 190 or on remote server 250.

At step 650, method 600 includes generating a performance report using the diagnostic test data received from the appliance. Generating the performance report may follow analyzing diagnostic test data. Performance report may include a supervisory performance report and a rental performance report. In some embodiments, the performance report includes a list of the current state of the set of user-selectable settings for the appliance. The performance report may include other information as previously described in system 100.

At step 660, method 600 includes communicating the performance report to a supervisory user. At step 670, method 600 includes providing access to the performance report to a rental user. Steps 660 and 670 may be performed following generation of the performance report. In some embodiments, step 670 may further include providing access to the performance report to a rental user only during the renting-report time frame. The renting-report time frame may be as specified in the appliance performance test parameters. Communication or providing access to the performance report may be performed as specified in the description of system 100, or in an equivalent manner, including printing and providing a physical copy of the performance report.

Embodiments described herein may further relate to a highly secured, reliable, and flexible cloud system that may create real connected appliances issue reports for rental managers and renters to increase the likelihood of renters having issue-free stays. Embodiments described herein may be based on an in-cloud request table and appliance performance analytics.

Embodiments may include a method wherein, following completion of a rental booking, the rental place or a property manager creates or fills in a request table which may have information about all connected appliances to be included in an appliance performance report and their respective profile data such as a serial number or a model number, a time or time period when remote testing is to be done, a time when a performance report will be available, a method of delivering the performance report, or a type of delivery mechanism for the performance report. A property manager or supervisory user may have the flexibility to set the remote testing time (e.g., after a previous rental user moves out and before a new rental user moves in). During a confirmation stage of the rental booking, a renter may have an option to choose how the report is delivered (e.g., by email or by message).

The system may receive inputs from the property manager in the request table and may run a two-step diagnostics test at the time set by the property manager. The two-step diagnostics test may include: a historical data analysis that may use cycle history data from the previous seven days and an in-cloud modelling to analyze the cycle history data; and a real time remote testing, which may determine which remote testing module to use for each appliance in the system based on profile data of each appliance. The in-cloud modeling (e.g., appliance performance analytics 196) may be continuously improved.

Embodiments of a method of creating and delivering a performance report for all the appliances in the rental place may include a rental user completing booking and a rental place manager receiving a rental user's choice of method to receive report, the rental place manager creating a new request table, running appliance performance analytics at the time scheduled by the rental place manager, and sending a performance report to the rental place property manager and to the rental user. Embodiments described herein may include a highly reliable, efficient, and flexible cloud system that may make it possible for rental place manager to get real appliance issue reports and for renters to have an increase in issue-free stays.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A non-transitory computer readable medium comprising computer-executable instructions that, when executed by one or more processors of an appliance performance report system, cause the one or more processors to:
receive appliance performance test parameters from a supervisory user of an appliance, the appliance performance test parameters comprising a test time frame for performing a self-diagnostic test on the appliance;
direct the appliance to perform the self-diagnostic test during the test time frame;
receive diagnostic test data from the appliance following performance of the self-diagnostic test;
generate a performance report using the diagnostic test data received from the appliance; and
communicate the performance report to the supervisory user.

2. The non-transitory computer readable medium of claim 1, wherein the one or more processors are further configured to provide access to the performance report to a rental user.

3. The non-transitory computer readable medium of claim 2, wherein the appliance performance test parameters further comprise a renting-report time frame for a rental user to have access to the performance report.

4. The non-transitory computer readable medium of claim 2, wherein the appliance performance test parameters further comprise a performance report delivery type, and wherein the one or more processors are configured to provide access to the performance report to the rental user in the performance report delivery type specified in the appliance performance test parameters.

5. The non-transitory computer readable medium of claim 2, wherein the performance report comprises a supervisory performance report having a detailed report of the diagnostic test data, and a rental performance report having a summary of the diagnostic test data, and
wherein the one or more processors are further configured to communicate the supervisory performance report to the supervisory user and provide access to only the rental performance report to the rental user.

6. The non-transitory computer readable medium of claim 1, wherein the appliance performance test parameters comprise appliance profile data related to the appliance.

7. The non-transitory computer readable medium of claim 1, wherein the one or more processors are further configured to analyze diagnostic test data following receipt of diagnostic test data from the appliance.

8. The non-transitory computer readable medium of claim 1, wherein the self-diagnostic test comprises a historical data analysis of at least one appliance parameter, the at least one appliance parameter being previously recorded over a predetermined time period.

9. The non-transitory computer readable medium of claim 8, wherein the at least one appliance parameter comprises at least one measurement of: temperature, current, voltage, pressure, water-level, or rotational speed.

10. The non-transitory computer readable medium of claim 1, wherein the performance report further comprises a list of a current state of a set of user-selectable settings for the appliance.

11. The non-transitory computer readable medium of claim 1, wherein the one or more processors are configured to communicate the performance report to the supervisory user prior to admittance of a rental user to a dwelling housing the appliance.

12. The non-transitory computer readable medium of claim 1, wherein the performance report includes an error event notification.

13. The non-transitory computer readable medium of claim 1, the appliance comprising a plurality of appliances, each appliance in the plurality of appliances capable of performing the self-diagnostic test specific to each corresponding appliance, and each appliance comprising a corresponding network interface,
wherein the diagnostic test data is organized by each appliance, and
wherein the performance report comprises a current status determination for each appliance in the plurality of appliances.

14. An appliance performance report method for determining and communicating conditions of appliances, the method comprising the steps of:
receiving appliance performance test parameters from a supervisory user of an appliance, the appliance performance test parameters comprising a test time frame for performing a self-diagnostic test;
directing the appliance to perform the self-diagnostic test during the test time frame;
receiving diagnostic test data from the appliance following performance of the self-diagnostic test;
generating a performance report using the diagnostic test data received from the appliance; and
communicating the performance report to the supervisory user.

15. The appliance performance report method of claim 14, the method further comprising providing access to the performance report to a rental user.

16. The appliance performance report method of claim 14, wherein the appliance performance test parameters further comprise a renting-report time frame for a rental user to have access to the performance report.

17. The appliance performance report method of claim 14, further comprising the step of providing access to the performance report to a rental user only during a renting-report time frame.

18. The appliance performance report method of claim 14, further comprising the step of analyzing diagnostic test data following receipt of diagnostic test data from the appliance, and
wherein generating the performance report further includes generating the performance report following analysis of diagnostic test data.

19. The appliance performance report method of claim 14, wherein the self-diagnostic test comprises a historical data analysis of at least one appliance parameter, the at least one appliance parameter previously recorded over a predetermined time period.

20. An appliance performance report system for communicating conditions of appliances capable of performing a self-diagnostic test and having a network interface, the appliance performance report system comprising:
a controller in operative communication with an appliance through the network interface, the controller being configured to:
receive appliance performance test parameters from a supervisory user of the appliance, the appliance performance test parameters comprising a test time frame for performing the self-diagnostic test;
direct the appliance to perform the self-diagnostic test during the test time frame;
receive diagnostic test data from the appliance following performance of the self-diagnostic test;
generate a performance report using the diagnostic test data received from the appliance; and
communicate the performance report to the supervisory user.
